(19) United States
(12) Patent Application Publication
(10) Pub. No.: US 2024/0012470 A1
(43) Pub. Date: Jan. 11, 2024

(54) FACIAL GESTURE MASK

(71) Applicant: Hewlett-Packard Development Company, L.P., Spring, TX (US)

(72) Inventor: Robert Paul Martin, Fort Collins, CO (US)

(73) Assignee: Hewlett-Packard Development Company, L.P., Spring, TX (US)

(21) Appl. No.: 18/250,523

(22) PCT Filed: Oct. 29, 2020
(86) PCT No.: PCT/US2020/058045

§ 371 Date: Apr. 25, 2023

(51) Int. Cl. G06F 3/01

(52) U.S. Cl. CPC G06F 3/011; G06F 3/167

(57) ABSTRACT

In an example implementation according to aspects of the present disclosure, a head mounted display (HMD) system which comprises an HMD positioned on an upper portion of a face of a wearer. The HMD system further comprises a facial gesture mask coupled to the HMD and positioned on a lower portion of the face of the wearer and comprising at least one light source and at least one camera to capture image data of the wearer. The HMD system also includes a processor to process the captured image data of the wearer to identify a gesture of the wearer.

### BACKGROUND

Extended reality (XR) technologies include virtual reality (VR), augmented reality (AR), and mixed reality (MR) technologies. XR technologies may use head mounted display (HMDs). An HMD is a display device that may be worn on the head. In VR technologies, the HMD wearer is immersed in a virtual world. In AR technologies, the HMD wearer's direct or indirect view of the physical, real-world environment is augmented. In MR technologies, the HMD wearer experiences a mixture of real-world and virtual-world environments.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1 illustrates a head mounted display (HMD) system with a facial gesture mask to capture an image of a wearer of an HMD, according to an example;

FIG. 2 illustrates a diagram of an HMD system with a facial gesture mask to capture an image of a wearer of the HMD, according to an example;

FIG. 3 illustrates a facial gesture mask to capture an image of a user, according to an example;

FIG. 4 illustrates a diagram of a facial gesture mask to capture an image of a user, according to an example; and

FIG. 5 illustrates a block diagram of a non-transitory readable medium storing machine-readable that upon execution cause a system to animate an expressive avatar of a wearer of an HMD using image data captured by a camera in a facial gesture mask, according to another example.

### DETAILED DESCRIPTION

A head mounted display (HMD) can be employed as an extended reality (XR) technology to extend the reality experienced by the HMD's wearer. An HMD can include a small display in front of the eyes of a wearer of the HMD to project images which immerse the wearer of the HMD with virtual reality (VR), augmented reality (AR), mixed reality (MR), or another type of XR technology. An HMD may also include outward facing cameras to capture images of the environment or external/inward facing cameras to capture images of the user.

In times of isolation and social distancing, the emergence of virtual collaboration and conferencing using video and images have become profound. As XR devices become more widely deployed and enabled with biometric/expressivity sensors, their utility as collaboration devices has accelerated. Many HMDs allow high-fidelity facial gesture capture but preclude the concurrent use of a traditional respiratory mask. Therefore, a mask function is used to maintain a user's respiratory distance but allow a robust capture of lower facial expressions and optionally upper body expressions or video.

Capturing images of a user allows facial expressions and gestures to be identified. The facial expressions and gestures may be used to create an expressive or emotive avatar of the user. In particular, the lower part of a user's face can be highly expressive and provide valuable data for mimicking expressions and gestures of the user using the expressive avatar. Therefore, high accuracy of data indicating a user's facial expressions and/or upper body gestures is needed.

Various examples described herein relate to an HMD system which comprises an HMD positioned on an upper portion of a face of a wearer. The HMD system further comprises a facial gesture mask coupled to the HMD and positioned on a lower portion of the face of the wearer and comprising at least one light source and at least one camera to capture image data of the wearer. The HMD system also includes a processor to process the captured image data of the wearer to identify a gesture of the wearer.

In yet another example, a facial gesture mask is positioned to cover a lower portion of a face of a user. The facial gesture mask comprises a light source to project light toward the face of the user, a camera to capture image data of the face of the user, and a communication interface to transfer the image data of the face of the user to an electronic device.

In other examples described herein, a non-transitory computer-readable medium comprises a set of instructions that when executed by a processor, cause the processor to capture an image of a wearer of an HMD as captured by a camera located on an internal surface of a facial gesture mask coupled to the HMD. A facial expression of the wearer is identified within the captured image of the wearer. Based on the identified gesture of the wearer, an emotive avatar of the wearer is animated.

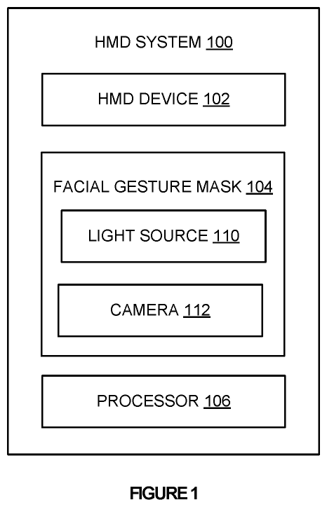

FIG. 1 illustrates an HMD system with a facial gesture mask to capture an image of wearer of an HMD, according to an example. HMD system 100 includes HMD device 102, facial gesture mask 104, and processor 106. Facial gesture mask 104 includes light source 110 and camera 112. HMD system 100 may be a VR device, an AR device, and/or a MR device. HMD system 100 may be able to process images of the user or transmit image and/or identified gesture data to another computing device. The identified gesture may be used to animate an expression of the user. However, the gesture data may also be used to authenticate the user of HMD system 100. In yet another example, the gesture data may be used to determine an emotional state of the user.

The expressive avatar may be used to display facial or body expressions to the user of HMD system 100 or to other users interacting with the user of HMD system 100. The expressive avatar may also be used to perform functions related to HMD system 100 or a computing device interacting with HMD system 100, such as communicate with other XR equipment (e.g., VR headsets, AR headsets, XR backpacks, etc.), a desktop or notebook PC, tablet, control a robotic computing device, authenticate a security computing device, train an Artificial Intelligence (Al) computing device, and the like.

HMD device 102 may include an enclosure that partially covers the field of view of the user. The enclosure may hold a display that visually enhances or alters a virtual environment for the user of HMD system 100. In some scenarios, the display can be a liquid crystal display, a light-emitting diode (OLED) display, or some other type of display that permits content or graphics to be displayed to the user. The display may cover a portion of the user's face, such as the portion above the mouth and/or nose of the user. HMD device 102 may also include a head strap which allows the enclosure of HMD device 102 to be secured to the upper portion of the user's face. In some instances, HMD device 102 may also include sensors or additional devices which may detect events and/or changes in the environment and transmit the detected events to processor 106.

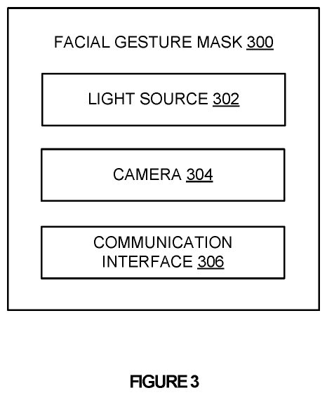

Still referring to FIG. 1, facial gesture mask 104 comprises an enclosure which covers the lower portion of a face of a user of HMD system 100. Facial gesture mask 104 may allow a user to have respiratory distance from other users. For example, facial gesture mask may include a material which enables the exchange of air to occur between one or more filters. The filters may be replaceable. Further, the material of the mask may be detachable to allow the material to be washed and/or replaced. Facial gesture mask 104 may include at least one light source, such as light source 110. Facial gesture mask 104 may also include at least one camera, such as camera 112, to capture images of the user. Further discussion of the light source and camera are discussed in FIG. 3.

Facial gesture mask 104 may be the same size or smaller as the bottom of the enclosure of the display for HMD device 102. However, facial gesture mask 104 may also be extendable to allow an increased amount of the user's body to captured by a camera enclosed in facial gesture mask 104. Facial gesture mask 104 may be positioned parallel to the user's body. This allows an image of the user's face and/or upper body to be captured by a camera of facial gesture mask 104. However, in some instances, the position of facial gesture mask 104 may be angled upward or downward to capture images of different portions of the user wearing HMD device 102. For example, if facial gesture mask 104 is tilted upward, the images captured by camera 112 may be focused on the user's mouth expressions. However, if facial gesture mask 104 is tilted downward, the images captured by camera 112 may be focused on a user's upper body gestures.

Facial gesture mask 104 may be attached to the enclosure of HMD device 102 by a hinge, latching mechanism, magnet, etc. For example, facial gesture mask 104 may be attached to the bottom edge of front plate or face plate of HMD device 102 by a magnet which allows facial gesture mask 104 to lock onto the bottom of HMD device 102.

Processor 106 may include a processing system and/or memory which store instructions to perform particular functions. In particular, processor 106 may direct camera 112 within facial gesture mask 104 to capture images of the user of HMD device 102. Processor 106 may use the images captured by camera 112 to determine gestures performed by the user and animate an expressive avatar. It should be noted that processor 106 may be coupled to HMD device 102, to facial gesture mask 104, and/or to an external host included as part of HMD system 100.

Processor 106 may extract data from the captured images. For example, processor 106 may determine control points for the user by using a grid system and locating coordinates which correspond to different points of the user's face or upper body. In some examples, processor 106 may be able to identify a user gesture, such as a smile. In either scenario, the extracted data may be used to animate an expressive avatar of the user, to authenticate a user, to determine an emotional state of the user, etc. For example, reference points may be identified and compared to stored reference points to determine that the gesture is a smile. In this scenario, HMD system 100 may use the gesture data to determine that the user is happy.

The expressive avatar may be animated by an external processing system (e.g., laptop computer system of the user or of other users, a cloud computing system, etc.). In this scenario, the extracted data may be transferred to the external processing system. Further in this example, the data may be compressed before transfer, especially if processor 106 is able to identify the gesture locally (e.g., identification of the smile). In other examples, processor 106 may be able to process the extracted data and generate the expressive avatar.

Furthermore, processor 106 may include a processing system which includes multiple processors which may perform a combination of functions to process the image data captured by camera 112. For example, a processor coupled to facial gesture mask 104 may process the raw footage image data collected by camera 112 and convert the raw feed data into standard protocol format which may be transferred to another processor over a communication interface.

In another example, another processor may be coupled to HMD device 102 to extract reference points from converted raw feed image data which may be used to identify a gesture of the user. In yet another example, another processor may be coupled to a host device in HMD system 100 which may animate an avatar of the user based on the determined gesture. It should be understood that the functions may be perform in one processor, or by a combination of processors included in HMD system 100.

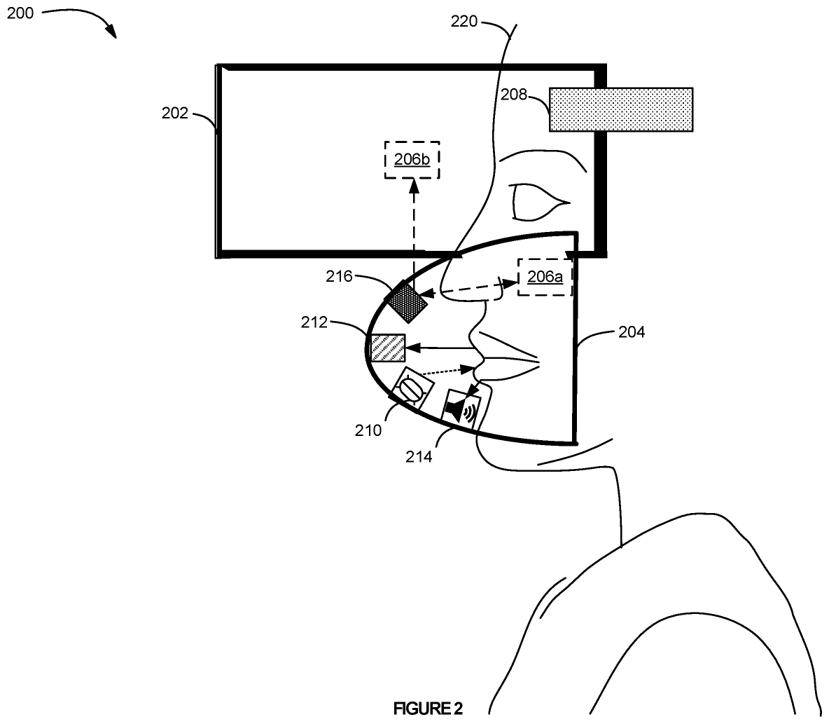

FIG. 2 illustrates a diagram of an HMD system with a facial gesture mask to capture an image of a wearer of the HMD, according to an example. FIG. 2 includes HMD system 200 and user 220. HMD system 200 may be an example of HMD system 100 from FIG. 1. However, HMD system 200 and the components included in HMD system 200 may differ in form or structure from HMD system 100 and the components included in HMD system 100.

HMD system 200 includes HMD device 202, facial gesture mask 204, and processors 206a-206b. HMD 200 also includes head strap 208. The lower portion of user's 220 face is covered by facial gesture mask 204. Facial gesture mask 204 is attached to the front plate of HMD device 202. Facial gesture mask 204 includes Illuminator 210, camera 212, microphone 214, and communication interface 216.

As indicated by the dotted-line arrow, illuminator 210 projects light onto the lower facial portion of user 220. As indicated by the solid-line arrows, camera 212 captures images of the lower facial portion of user 220 by capturing image data, and microphone 214 captures audio data from user 220. Although not shown for clarity, processor 206a receives raw image data from camera 212 and raw audio data from microphone 214.

Processor 206a then converts the raw image data and raw audio data into a standard format for communication interface 216 to transfer to processor 206b. Processor 206b then receives the converted image data and audio data and identifies gestures and dialog (i.e., facial expressions and/or upper body movements) of user 220 based on the images captured by camera 212 and the audio captured by microphone 214.

FIG. 3 illustrates a facial gesture mask to capture an image of a user, according to an example. FIG. 3 includes facial gesture mask 300. Facial gesture mask 300 may be an example of facial gesture mask 104 from FIG. 1 and facial gesture mask 204 from FIG. 2. However, facial gesture mask 300 and the components included in facial gesture mask 300 may differ in form or structure from facial gesture mask 104 and the components included in facial gesture mask 104, and from facial gesture mask 204 and the components included in facial gesture mask 204.

Facial gesture mask 300 include light source 302, camera 304, and communication interface 306. Light source 302 may comprise any device capable of projecting light onto a face of a user wearing facial gesture mask 300. Light source 302 may illuminate portions of a user's face and/or upper body using projected light. For example, light source 302 may be a light emitting diode (LED) illuminator, a lamp, a laser, etc.

In some scenarios, light source 302 may project light in the visible spectrum or in the non-visible spectrum, such as an IR illuminator, or an ultraviolet (UV) illuminator. By projecting the light onto the user's face and/or upper body, the user's features may be more consistently illuminated (e.g., lowers shadowing below the user's upper or lower lip). It should also be noted that in other examples, light source 302 may emit diffused light onto the face of the user.

Camera 304 captures images of the user's face and/upper body, as illuminated by the light that light source 302 projects onto the face of the user wearing facial gesture mask 300. Camera 304 can be a still image or a moving image (i.e., video) capturing device. Examples of camera 304 include semiconductor image sensors like charge-coupled device (CCD) image sensors and complementary metal-oxide semiconductor (CMOS) image sensors.

It should be noted that multiple light sources and cameras may be included in facial gesture mask 300. Further, light source 302 and camera 304 may be located in various locations within facial gesture mask 300. In some examples, a camera may be placed on either side of the user's face/nose. In this example, multiple images may be captured at different angles of the user's face. This may allow cameras to be able to view both sides of the user's face by deciphering and separating out the image data for the two images and then performing stereo imaging. By performing stereo imaging, additional depth information may be collected and processed to generate a three-dimensional (3D) view of an expressive avatar using the facial expressions and/or upper body gestures acted out by a user.

Although not illustrated in FIG. 3, facial gesture mask 300 may be detachable from an HMD. For example, facial gesture mask 300 may be attached to HMD 100 using a latching mechanism or a magnetic mechanism when in use. In yet another example, facial gesture mask 300 may act as a physical privacy barrier when placed over the lower portion of a user's face. More specifically, facial gesture mask 300 may function as a visible or audio shield of the lower facial region for the user of an HMD. For example, a user using VR conferencing in a public place may not want bystanders to be able to lip read what the user is saying during the call. In this scenario, facial gesture mask 300 may act as a visual shield for the mouth of the user of the HMD.

Communication interface 306 may include communication connections and devices that allow for communication with other computing systems, such as a processor in an HMD and/or a host device (not shown), over communication networks (not shown). Examples of connections and devices that together allow for inter-system communication may include universal serial bus (USB) connections, network interface cards, antennas, power amplifiers, RF circuitry, transceivers, and other communication circuitry. In particular, communication interface 306 may transfer the captured image data to a processor which identifies user gestures. The user gestures may be used to determine a user's emotional state, animate an avatar, etc.

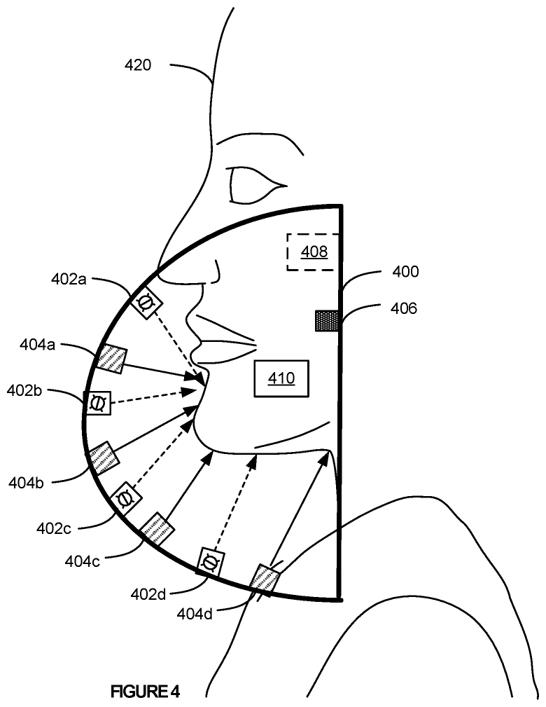

FIG. 4 illustrates a diagram of a facial gesture mask to capture an image of a wearer of the HMD, according to an example. FIG. 4 includes facial gesture mask 400 and user 420. Facial gesture mask 400 may be an example of facial gesture mask 104 from FIG. 1, facial gesture mask 204 from FIG. 2, and facial gesture mask 300 from FIG. 3. However, of facial gesture mask 104 from FIG. 1, facial gesture mask 204 from FIG. 2, and facial gesture mask 300 from FIG. 3 and their components may differ in form or structure from facial gesture mask 400 and the components included in facial gesture mask 400.

Facial gesture mask 400 includes light sources 402a-402d, cameras 404a-404d, communication interface 406, processor 408, and removeable filter 410. The lower portion of user's 420 face and upper portion of user's 420 body is covered by facial gesture mask 400. Although not shown, facial gesture mask 400 may be attachable to a front plate of an HMD device.

As indicated by the dotted-line arrows, light sources 402a-402d project light onto the lower facial portion and upper body portion of user 420. As indicated by the solid-line arrows, cameras 404a-404d capture image data of the lower facial portion and upper body portion of user 420. Communication interface 406 may transfer image data to be processed in an external host device, to an HMD attached to facial gesture mask 400, and/or to processor 208. Processor 408 may identify gestures (i.e., facial expressions and/or upper body movements) of user 420 based on the images captured by cameras 404a-404d. Furthermore, removeable filter 410 may filter air being exchanged between the internal and external portion of facial gesture mask 400.

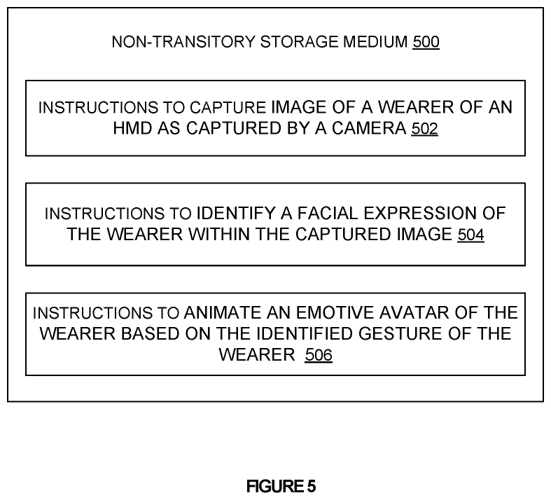

FIG. 5 illustrates a block diagram of a non-transitory readable medium storing machine-readable that upon execution cause a system to animate an expressive avatar of a wearer of an HMD with a facial gesture mask, according to another example. Storage medium is non-transitory in the sense that is does not encompass a transitory signal but instead is made up of a memory component configured to store the relevant instructions.

The machine-readable instructions include instructions 502 to capture an image of a wearer of an HMD as captured by a camera located on an internal surface of a facial gesture mask coupled to the HMD. The machine-readable instructions also include instructions 504 to identify a facial expression of the wearer within the captured image of the wearer. Furthermore, the machine-readable instructions also include instructions 506 to animate an emotive avatar of the wearer based on the identified gesture of the wearer.

In one example, program instructions 502-506 can be part of an installation package that when installed can be executed by a processor to implement the components of a computing device. In this case, non-transitory storage medium 500 may be a portable medium such as a CD, DVD, or a flash drive. Non-transitory storage medium 500 may also be maintained by a server from which the installation package can be downloaded and installed. In another example, the program instructions may be part of an application or applications already installed. Here, non-transitory storage medium 500 can include integrated memory, such as a hard drive, solid state drive, and the like.

The functional block diagrams, operational scenarios and sequences, and flow diagrams provided in the Figures are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be included as a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

What is claimed is:

1. A head mounted display (HMD) system comprising:
an HMD device positioned on an upper portion of a face of a wearer;
a facial gesture mask coupled to the HMD and positioned on a lower portion of the face of the wearer and comprising at least one light source and at least one camera to capture image data of the wearer; and
a processor to process the captured image data of the wearer to identify a gesture of the wearer.

2. The HMD system of claim 1, wherein the system further comprises a communication interface to a transfer the captured image data of the wearer to the processor to process the captured image data of the wearer.

3. The HMD system of claim 2, wherein the system further comprises the processor and wherein the processor is to identify a gesture of the wearer.

4. The system of claim 1, wherein the gesture comprises at least one of a facial gesture or an upper body gesture.

5. The HMD system of claim 1, wherein the facial gesture mask further comprises a microphone to capture audio data of the wearer.

6. A facial gesture mask positioned to cover a lower portion of a face of a user, the facial gesture mask comprising:
a light source to project light toward the face of the user;
a camera to capture image data of the face of the user; and
a communication interface to transfer the image data of the face of the user to an electronic device.

7. The facial gesture mask of claim 6, further comprising a processor coupled to the facial gesture mask to identify a gesture of the user based on the captured image data of the face of the user.

8. The facial gesture mask of claim 7, wherein the communication interface transfers the identified gesture of the user to a host device.

9. The facial gesture mask of claim 7, wherein the processor is to animate an emotive avatar of the user based on the identified gesture of the user.

10. The facial gesture mask of claim 6, wherein the facial gesture mask is coupled to a head mounted display (HMD).

11. The facial gesture mask of claim 6, wherein
the light source further projects light toward an upper body of the user;
the camera further captures image data of the upper body of the user; and
the communication interface further transfers the image data of the upper body of the user to the electronic device.

12. The facial gesture mask of claim 6, further comprising a detachable material which secures the facial gesture mask to the lower portion of the face of the user.

13. The facial gesture mask of claim 6, further comprising at least one removeable air filter which limits the exposure of contaminated air from being transferred to the user through the facial gesture mask.

14. The facial gesture mask of claim 6, further comprising a microphone positions in the facial gesture mask to capture audio data from the user.

15. A non-transitory computer-readable medium comprising a set of instructions that when executed by a processor, cause the processor to:
capture an image of a wearer of a head mounted display (HMD) as captured by a camera located on an internal surface of a facial gesture mask coupled to the HMD;
identify a facial expression of the wearer within the captured image of the wearer; and
animate an emotive avatar of the wearer based on the identified gesture of the wearer.
